(19) United States
(12) Patent Application Publication
(10) Pub. No.: US 2013/0267185 A1
(43) Pub. Date: Oct. 10, 2013

(54) TRANSCEIVER HAVING AN ON-CHIP CO-TRANSFORMER

(71) Applicants: Yu-Hsin Chen, Taipei (TW); Kai-Yi Huang, Taipei (TW)

(72) Inventors: Yu-Hsin Chen, Taipei (TW); Kai-Yi Huang, Taipei (TW)

(73) Assignee: REALTEK SEMICONDUCTOR CORP., HSINCHU (TW)

(21) Appl. No.: 13/857,922

(22) Filed: Apr. 5, 2013

(30) Foreign Application Priority Data
Apr. 6, 2012 (TW) 101112241

(51) Int. Cl. H04B 1/44

(52) U.S. Cl. CPC H04B 1/44
USPC 455/78

(57) ABSTRACT

A transceiver formed on an integrated-circuit substrate is disclosed. The transceiver includes: a co-transformer comprising first, second and third windings which wrap each other but are separated from each other; a power amplifier coupled to the co-transformer; and a low-noise amplifier coupled to the co-transformer; wherein the co-transformer is configured for converting a first signal from the power amplifier into a second signal to be transmitted by an antenna when the transceiver is in its transmitter mode, and for converting a third signal from the antenna into a fourth signal to be outputted to the low-noise amplifier when the transceiver is in its receiver mode.

### CROSS-REFERENCE TO RELATED APPLICATIONS STATEMENT

This non-provisional application claims priority under 35 U.S.C. § 119(a) on Patent Application No. 101112241 filed in Taiwan, R.O.C. on Apr. 6, 2012, the entire contents of which are hereby incorporated by reference.

### TECHNICAL FIELD

The present disclosure relates to a transceiver, and more particularly, to a transceiver having an on-chip co-transformer with multiple windings for wireless communications.

### TECHNICAL BACKGROUND

Transmitters, antennae and receivers are essential components in the wireless communication system, where signals transmitted in the air are of single-ended type while signals processed in the differential circuits of the transmitters are of differential type. The transmitters are used to convert differential signals processed in their interior circuits into single-ended signals before their output signals are forwarded to the antennae to be radiated electromagnetically into the air. On the other hand, the receivers are used to convert single-ended signals received by the antennae into differential signals before the signals are forwarded to the low noise amplifier (LNA) in the receivers. Usually, the conversion between the differential and single-ended signals is performed by a transformer balun, which has a transformer coil at each of its transmitting and receiving terminals. If the transformer coils are realized in the form of integrated-circuit (IC) chip, they may spend a quite large chip area.

As the advance of the system on chip (SoC) in the IC manufacturing, a discrete transformer is gradually replaced by an integrated transformer, which can be applied to the radio-frequency integrated circuit (RFIC). However, some passive devices like inductors and transformers often consume a large chip area. Consequently, it is in need to develop a new integrated-circuit transceiver with less passive devices or with a smaller layout area.

### TECHNICAL SUMMARY

Therefore, one of the objects of the present disclosure is to propose a transceiver with an on-chip multiple-winding co-transformer, which is shared by its transmitter circuit and receiver circuit, so that the low noise amplifier of the receiver circuit and the power amplifier of the transmitter circuit can be connected in good impedance matching and the transceiver can be fabricated in a less chip area.

According to one aspect of the present disclosure, one embodiment provides a transceiver formed on an integrated-circuit substrate. The transceiver includes: a co-transformer comprising first, second and third windings which wrap each other but are separated from each other; a power amplifier connected to the co-transformer; and a low-noise amplifier connected to the co-transformer; wherein the co-transformer is configured for converting a first signal from the power amplifier into a second signal to be transmitted by an antenna when the transceiver is in its transmitter mode, and for converting a third signal from the antenna into a fourth signal to be outputted to the low-noise amplifier when the transceiver is in its receiver mode.

According to another aspect of the present disclosure, another embodiment provides a transceiver formed on an integrated-circuit substrate. The transceiver includes: a co-transformer formed on an integrated-circuit substrate and comprising first, second and third windings which wrap each other but are separated from each other; a power amplifier connected to the co-transformer; and a low-noise amplifier connected to the co-transformer; wherein the co-transformer is configured for converting a first differential signal from the power amplifier into a first single-ended signal to be transmitted, and for converting a second single-ended signal received into a second differential signal to be outputted to the low-noise amplifier.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 schematically shows a circuit diagram of a transceiver according to an embodiment of the present disclosure.

FIG. 2A schematically shows a layout diagram of the co-transformer according to the embodiment.

FIG. 2B is a cross-sectional diagram of the co-transformer taken along the A-A′ line in FIG. 2A.

FIG. 2C shows the wiring layout of the first winding in FIG. 2A.

FIG. 2D shows the wiring layout of the second winding in FIG. 2A.

FIG. 2E shows the wiring layout of the third winding in FIG. 2A.

FIG. 3 shows a circuit diagram of the transceiver according to the embodiment schematically.

FIG. 4 shows a circuit diagram of the transceiver according to the embodiment schematically.

### DESCRIPTION OF THE EXEMPLARY EMBODIMENTS

For further understanding and recognizing the fulfilled functions and structural characteristics of the disclosure, several exemplary embodiments cooperating with detailed description are presented as the following. Reference will now be made in detail to the preferred embodiments, examples of which are illustrated in the accompanying drawings.

In the following description of the embodiments, it is to be understood that when an element such as a layer (film), region, pattern, or structure is stated as being “on” or “under” another element, it can be “directly” on or under another element or can be “indirectly” formed such that an intervening element is also present. Also, the terms such as “on” or “under” should be understood on the basis of the drawings, and they may be used herein to represent the relationship of one element to another element as illustrated in the figures. It will be understood that this expression is intended to encompass different orientations of the elements in addition to the orientation depicted in the figures, namely, to encompass both “on” and “under”. In addition, although the terms “first”, “second” and “third” are used to describe various elements, these elements should not be limited by the term. Also, unless otherwise defined, all terms are intended to have the same meaning as commonly understood by one of ordinary skill in the art.

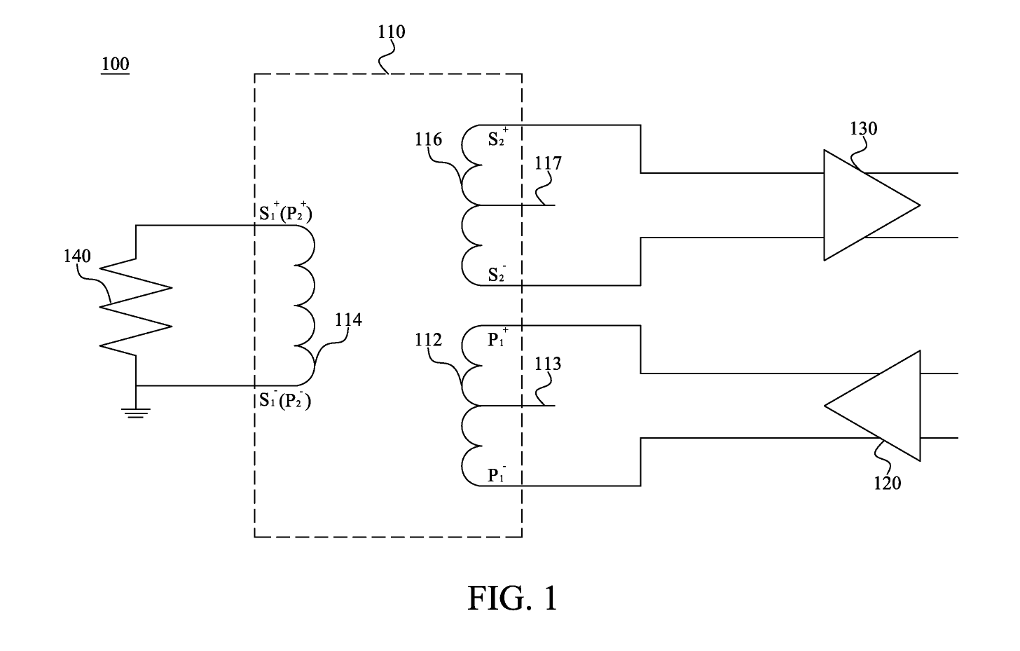

FIG. 1 schematically shows a circuit diagram of a transceiver according to an embodiment of the present disclosure. The transceiver 100 may comprise a co-transformer 110, a power amplifier 120, and a low-noise amplifier 130, which can be formed on a semiconductor substrate or wafer by using the integrated-circuit manufacturing. The transceiver 100 may be connected to an antenna 140, and it can function as a transmitter in the transmission mode and as a receiver in the reception mode. The power amplifier 120 is connected to the co-transformer 110, and the co-transformer 110 is connected to the low-noise amplifier 130. The co-transformer 110 is designed in the form of a transformer balun with multiple windings, to perform conversions between single-ended and differential signals in the communication system.

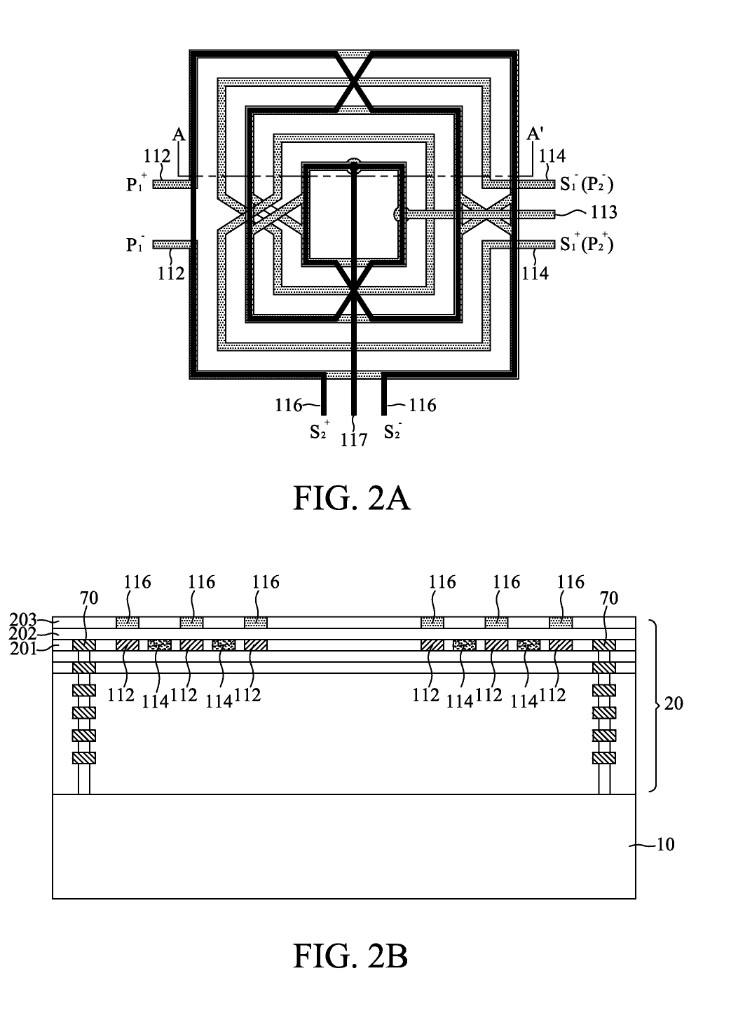

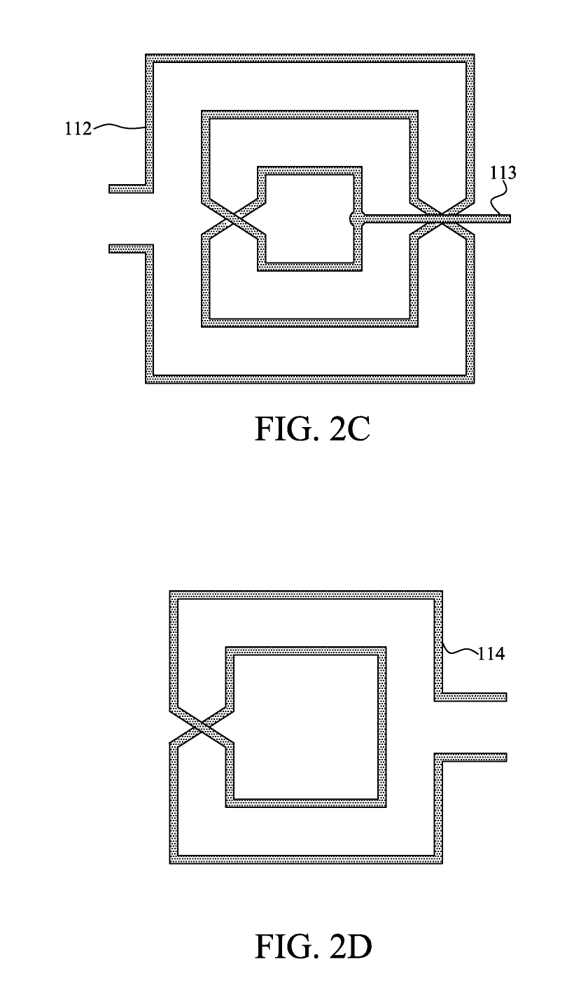

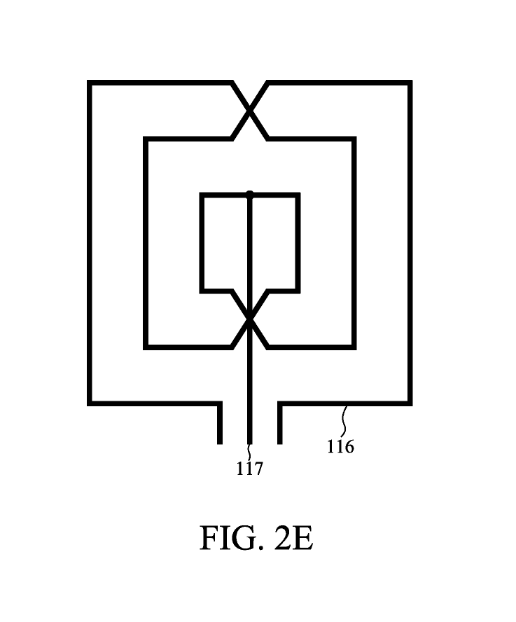

FIG. 2A schematically shows a layout diagram of the co-transformer 110 according to the embodiment, and FIG. 2B is a cross-sectional diagram of the co-transformer 110 taken along the A-A′ line in FIG. 2A. As shown in FIG. 2A, the co-transformer 110 comprises a multi-winding structure formed in a multi-layered structure 20 on the semiconductor substrate 10. The multi-winding structure comprises a first winding 112, a second winding 114, and a third winding 116, which wrap each other but are separated from each other, so as to form a transformer with three windings. In another embodiment, the co-transformer 110 may further include a guard ring 70, preferably, which can be composed of stacked metal rings surrounding the multi-winding structure and formed in the multi-layered structure 20, as shown in FIG. 2B. The guard ring 70 can keep the co-transformer 110 isolated, so that the transformer inside the guard ring 70 and the devices outside the guard ring 70 may not interfere with each other electromagnetically. Preferably, there's no more guard ring needed inside the guard ring 70.

The first winding 112 is composed of multiple turns of first coils and disposed substantially in a first layer 201 of the multi-layered structure 20. FIG. 2C shows the wiring layout of the first winding 112 in FIG. 2A. The first coils, wrapping each other, are basically parallel to each other, except the intersections between the coils. A bridge jumper is formed at each of the intersections, so that a part of wiring path of the first coils can be routed by the way in the upper or lower layer of the first layer 201. Thus, the first coils can connected one by one to be a continuous wiring path, with no short-circuited intersection between them. To improve the coil density, the first coils may wrap around each other in a helix-like pattern. The first winding 112 can further includes two connection terminals and a first center tap 113, which is a tap located at the winding center, to be used for a two-ended signal, such as a differential signal. The first center tap 113 can have its access wire with a direction angle of 0°, 90°, 180°, or the other proper degree against the access wire of the connection terminals of the first winding 112, so that it can be connected to the other devices on the chip in a shortest wiring path. In addition, the access wire of the first center tap 113 can be prevented from being short-circuited to the first winding 112 by using the bridge jumpers, as described above.

The second winding 114 is composed of multiple turns of second coils and disposed substantially in the first layer 201 (the same layer in which the first winding 112 is distributed) of the multi-layered structure 20. FIG. 2D shows the wiring layout of the second winding 114 in FIG. 2A. Basically, the second coils wrap each other and their wiring configuration is similar to that of the first coils of the first winding 112 as described above. Wherein, wiring patterns of the first and second windings 112 and 114 are in squire or rectangle shapes; but it is not limited thereto, they can be shaped in a circle, octagon, or another shape which can improve performances of the co-transformer 110 or reduce its occupational chip area.

The first and second windings 112 and 114 are disposed in the same layer 201, so lateral electromagnetic coupling can be formed between the windings 112 and 114 to function as a transformer. Wirings of the first and second windings 112 and 114 are spatially separated from and parallel to each other. The number of turns in the first winding 112 can be different from that of the second winding 114, so that the ratio of the number of turns in the primary winding to the number of turns in the secondary winding of the transformer can be set according to practical applications. In another embodiment, the number of turns in the first winding 112 can be larger than that of the second winding 114, and the outermost coil of the second winding 114 surrounds outside the first winding 112. To improve efficiency of the electromagnetic coupling effect, the first and second coils can be arranged in an inter-digital wiring configuration as shown in FIG. 2A according the embodiment. Such an arrangement may cause a denser wiring pattern, so that the on-chip transformer can have a minimum chip area. In addition, the wiring path of the second winding 114 can be prevented from being short-circuited to that of the first winding 112 at their intersections by using the bridge jumpers, as described above.

The third winding 116 is composed of multiple turns of third coils and is disposed substantially in a second layer 203 (different from the first layer 201 in which the first and second winding 112 and 114 are distributed) of the multi-layered structure 20. A layer 202 of insulator material is interposed between the first layer 201 and the second layer 202 to separate them. FIG. 2E shows the wiring layout of the third winding 116 in FIG. 2A. The third winding 116 can further includes two connection terminals and a second center tap 117, which is a tap located at the winding center, to be used for a two-ended signal, such as a differential signal. The second center tap 117 can have its access wire with a direction angle of 0°, 90°, 180°, or the other proper degree against the access wire of the connection terminals of the third winding 116.

As shown in FIGS. 2A and 2B, vertical views of the second and third windings 114 and 116 upon the substrate 10 are located inside that of the outermost coil of the first winding 112. In other words, layouts of the second and third windings 114 and 116 projected vertically onto the substrate 10 are located inside that of the outermost coil of the first winding 112. One of the three windings 112/114/116 has a wiring layout surrounding those of the other two windings. In addition, the second layer 203 is above the first layer 201 as shown in FIG. 2B, but it can be located below the first layer 201 in another embodiment, so that the third winding 116 is located below the first winding 112. In another embodiment, each of the first, second and third windings 112/114/116 can be formed in at least two layers in the multi-layered structure 20. For example, the first winding 112 can be partly formed in the first layer 201 and partly formed in the second layer 203. In some embodiments, the electromagnetic coupling among the first, second and third winding 112/114/116 can be completely in vertical direction, completely in lateral direction, or partly in vertical direction and partly in lateral direction.

As a consequence, the co-transformer 110 shown in FIG. 2A is an on-chip transformer having three windings, and its equivalent circuit can be illustrated in the dash box of FIG. 1. The first winding 112, second winding 114 and third winding 116 wrap each other while are spatially separated from each other. The lateral electromagnetic coupling between the first and second windings 112 and 114 may function as a first transformer. As shown in FIG. 1, the first winding 112 acts as the primary winding of the first transformer with its positive-pole and negative-pole connection terminals respectively denoted as P₁⁺ and P₁⁻, while the second winding 114 acts as the secondary winding of the first transformer with its positive-pole and negative-pole connection terminals respectively denoted as S₁⁺ and S₁⁻. The first center tap 113 is formed in the first winding 112, so that the first transformer can convert a differential signal processed in the transmitter of wireless communication into a single-ended signal radiated electromagnetically in the air. On the other hand, the vertical electromagnetic coupling between the second and windings 114 and 116 may function as a second transformer. The second winding 114 acts as the primary winding of the second transformer with its positive-pole and negative-pole connection terminals respectively denoted as P₂⁺ and P₂⁻, while the third winding 116 acts as the secondary winding of the second transformer with its positive-pole and negative-pole connection terminals respectively denoted as S₂⁺ and S₂⁻. Wherein, the second winding 114 is the common winding shared by the first and second transformers. The second center tap 117 is formed in the third winding 116, so that the second transformer can convert a single-ended signal into a differential signal. Thereby, the second transformer can be used to convert single-ended signals received by the antenna 140 into differential signals to be processed by the low noise amplifier 130 in the receiver. In other words, the co-transformer 110 can function as a transformer balun, to be applied to transmission and reception of wireless signals. For each of the first and second transformers, connection terminals of its primary and secondary windings can be connected to their access wires, which are angled at 180°, 90°, 45°, or any suitable angle. Formed along a suitable direction, the access wires causes that the connection terminals of the windings can be connected to the other devices on the chip in a shortest wiring path, so that the parasitical capacitors and inductors induced by transmission-line wiring can be diminished so as to optimize the circuit layout.

As shown in FIG. 1, the primary and secondary windings of the first transformer are connected to the power amplifier 120 and the antenna 140, respectively. In other words, the connection terminals P₁⁺ and P₁⁻ of the first winding 112 are connected to the power amplifier 120, and the connection terminals S₁⁺ and S₁⁻ of the second winding 114 are connected to the antenna 140 with the connection terminal S₁⁻ grounded. On the other hand, the primary and secondary windings of the second transformer are connected to the antenna 140 and the low-noise amplifier 130, respectively. In other words, the connection terminals P₂⁺ and P₂⁻ of the second winding 114 are connected to the antenna 140, and the connection terminals S₂⁺ and S₂⁻ of the third winding 116 are connected to the low-noise amplifier 130.

In the embodiment, the first and second windings 112 and 114 are disposed in the same layer 201 of the multi-layered structure 20, and thus the lateral electromagnetic coupling can be formed between the first and second windings 112 and 114 to function as the first transformer, which can convert between single-ended and two-ended signals. The first center tap 113 of the first winding 112 can be provided for use in connection to the power amplifier 120. On the other respect, the second winding 114 and the third winding 116 are disposed in the layers 201 and 203, respectively, and thus the vertical electromagnetic coupling can be formed between the second and third windings 114 and 116 to function as the second transformer. The second center tap 117 of the third winding 116 can be provided for use in connection to the low-noise amplifier 130. Consequently, the on-chip co-transformer 110 acts as a transformer balun with two center taps 113 and 117.

Referring to FIG. 1, the wireless-communication transceiver 100 of the embodiment can operate as follows. When the transceiver 100 is in the transmission mode, the co-transformer 110 can convert a differential signal from the power amplifier 120 into a single-ended signal to be transmitted or radiated into the air by the antenna 140. For example, the first transformer composed of the first and second windings 112 and 114 converts between the differential and single-ended signals, in which the first winding 112 acts as the primary winding of the first transformer, and the second winding 114 acts as the secondary winding of the first transformer. The first transformer converts the differential output signal of the power amplifier 120 into the single-ended signal, to be transmitted to the antenna 140 for radiation out into the air. On the other respect, when the transceiver 100 operates in the reception mode, the co-transformer 110 can convert a single-ended signal received from the air by the antenna 140 into a differential signal to be transmitted to the low-noise amplifier 130. For example, the second transformer composed of the second and third windings 114 and 116 converts between the differential and single-ended signals, in which the second winding 114 acts as the primary winding of the second transformer, and the third winding 116 acts as the secondary winding of the second transformer. The second transformer converts the single-ended input signal from the antenna 140 into the differential signal, to be transmitted to the low-noise amplifier 130 for signal processing. In the circuit of FIG. 1, the first winding 112 connected to the power amplifier 120 and the third winding 116 connected the low-noise amplifier 130 are spatially separated from each other, so their wiring layouts can be preferably designed according to operating characteristics of the power amplifier 120 and the low-noise amplifier 130, respectively. By adjusting the ratio of the numbers of turns among the windings 112/114/116, the impedances of the first and second transformers can preferably match to that of the antenna 140. Moreover, the wiring path of each winding 112/114/116 can have its wire width according to power density of the power amplifier 120 and noise figure of the low-noise amplifier 130.

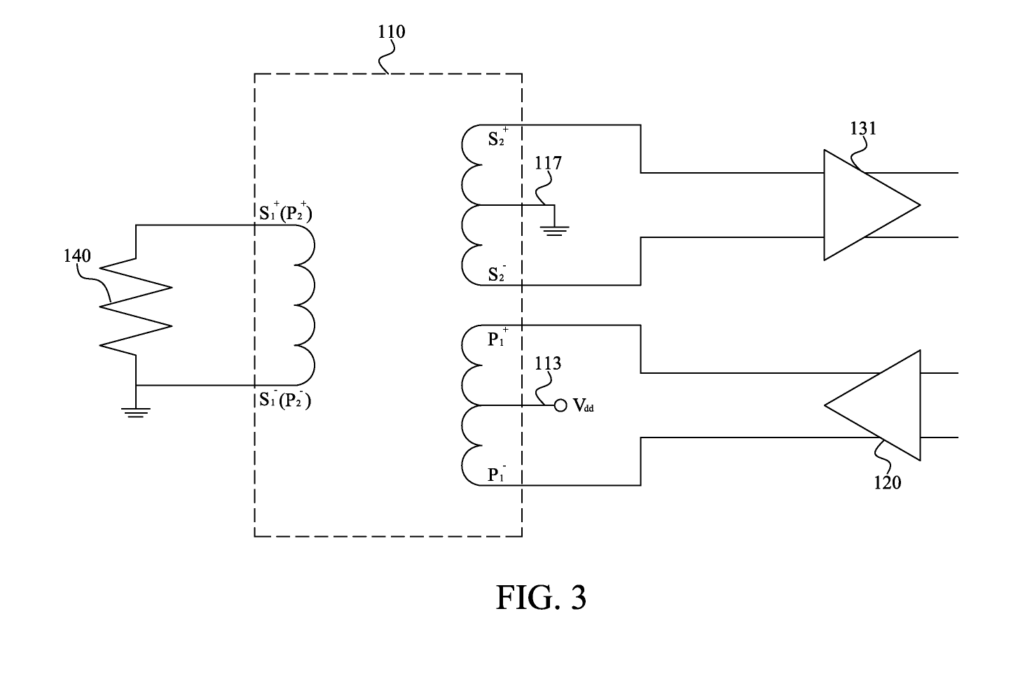

In the embodiment, the low-noise amplifier 130 can have a circuit configuration of common gate or common source. As a first example, FIG. 3 shows a circuit diagram of the transceiver according to the embodiment schematically, in which the low-noise amplifier 131 is formed of a common-gate configuration. The first center tap 113 is connected to a DC voltage source V_{dd} of the power amplifier 120, wherein V_{dd} has its voltage value depending on practical applications of the power amplifier. The second center tap 117 is grounded to provide the low-noise amplifier 131 with a current path to the ground, so that the problem in the prior art where a transformer balun is unable to be connected to a common-gate low-noise amplifier can be resolved. Due to the characteristic of broadband matching in a low-noise amplifier of common-gate configuration, there is no extra matching device needed for the transceiver circuit and thus the cost can be lowered further.

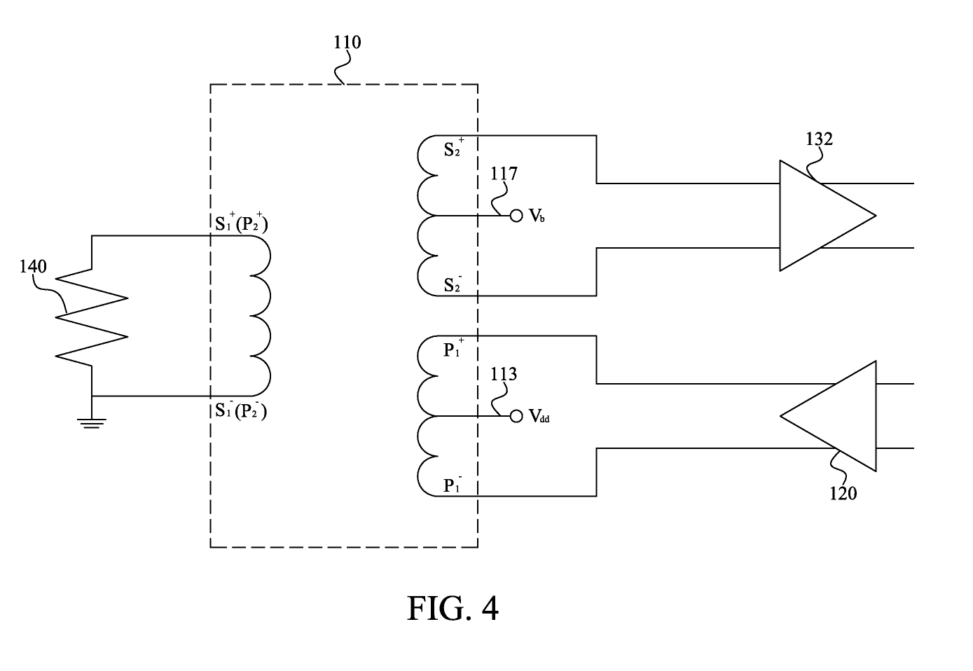

As a second example, FIG. 4 shows a circuit diagram of the transceiver according to the embodiment schematically, in which the low-noise amplifier 132 is formed of a common-source configuration having a transistor with a biased voltage V_{b} at its input terminals. The biased voltage V_{b} is connected to the gate of the transistor through the co-transformer 110, in which V_{b} has its voltage value depending on practical applications of the low-noise amplifier. The first center tap 113 is connected to a DC voltage source V_{dd} of the power amplifier 120, and the second center tap 117 is connected to the biased voltage V_{b} of the low-noise amplifier 132. Thereby, at least two AC coupling capacitors can be saved in the fabrication of the transceiver chip.

In the embodiments, the co-transformer 110 functions as the balun transformer in the transceiver 100 in which the first winding 112 connected to the power amplifier 120 and the third winding 116 connected to the low-noise amplifier 130 are disposed in different layers of the multi-layered structure 20. In the integrated-circuit layout of the transceiver 100, the connection terminals of the windings can be designed to extend their access wiring paths in any suitable orientation. For example, the connection terminals of the third winding 116 have their access wiring path in a direction vertical to that of the first winding 112 (or the second winding 114). Thereby, the access wiring paths may not intersect each other and this is advantageous to the integrated circuit layout of the device.

In the other embodiment, only the co-transformer 110 is formed on an integrated-circuit substrate to be a discrete on-chip transformer, and the power amplifier 120 and the low-noise amplifier 130 are also of discrete device. The co-transformer 110, the power amplifier 120 and the low-noise amplifier 130 are mounted on a printed circuit board to construct the transceiver 100 as shown in FIG. 1.

As set forth in the embodiments, transformers with multiple windings can be integrated as a single-chip device with a small surface area and good impedance matching. With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A transceiver formed on an integrated-circuit substrate, the transceiver comprising:
a co-transformer, comprising first, second and third windings which wrap each other but are separated from each other;
a power amplifier, coupled to the co-transformer; and
a low-noise amplifier, coupled to the co-transformer;
wherein the co-transformer is configured for converting a first signal from the power amplifier into a second signal to be transmitted by an antenna when the transceiver is in its transmitter mode, and for converting a third signal from the antenna into a fourth signal to be outputted to the low-noise amplifier when the transceiver is in its receiver mode.

2. The transceiver according to claim 1, wherein the co-transformer converts between the first and second signals by using the first and second windings, and converts between the third and fourth signals by using the second and third windings.

3. The transceiver according to claim 1, wherein the conversion between the first and second signals is performed by lateral electromagnetic coupling between the first and second windings.

4. The transceiver according to claim 3, wherein the conversion between the third and fourth signals is performed by vertical electromagnetic coupling between the second and third windings.

5. The transceiver according to claim 1, wherein the co-transformer converts between the first and second signals by using the first and second windings, in which the first signal is of differential input and the second signal is of single-ended output.

6. The transceiver according to claim 5, wherein the co-transformer converts between the third and fourth signals by using the second and third windings, in which the third signal is of single-ended input and the fourth signal is of differential output.

7. The co-transformer according to claim 1, wherein the first and third windings have a center tap each.

8. The co-transformer according to claim 1, wherein one of the first, second and third windings has a layout surrounding the other two windings.

9. A transceiver, comprising:
a co-transformer, formed on an integrated-circuit substrate and comprising first, second and third windings which wrap each other but are separated from each other;
a power amplifier, coupled to the co-transformer; and
a low-noise amplifier, coupled to the co-transformer;
wherein the co-transformer is configured for converting a first differential signal from the power amplifier into a first single-ended signal to be transmitted, and for converting a second single-ended signal received into a second differential signal to be outputted to the low-noise amplifier.

10. The transceiver according to claim 9, wherein the co-transformer converts between the first differential and single-ended signals by using the first and second windings, and converts between the second single-ended and differential signals by using the second and third windings.

11. The transceiver according to claim 10, wherein both the first and second windings are formed substantially in a first metal layer.

12. The transceiver according to claim 11, wherein the third winding is formed substantially in a second metal layer.

13. The transceiver according to claim 9, wherein the first and third windings have a center tap each.

14. The transceiver according to claim 10, wherein vertical views upon the substrate of the second and third windings are located inside that of the outermost coil of the first winding.
